(19) United States
(12) Patent Application Publication
(10) Pub. No.: US 2014/0074834 A1
(43) Pub. Date: Mar. 13, 2014

(54) Storage Block Metadata Tagger

(71) Applicant: Robert Pike, Woodinville, WA (US)

(72) Inventor: Robert Pike, Woodinville, WA (US)

(73) Assignee: TRANSPARENT IO, INC., Woodinville, WA (US)

(21) Appl. No.: 13/612,961

(22) Filed: Sep. 13, 2012

(51) Int. Cl. G06F 17/30

(52) U.S. Cl. 707/736; 707/E17.044

(57) ABSTRACT

A storage management system may monitor file activity from a file system and tag storage blocks with metadata. The metadata may be used by the storage management system to apply various policies to the blocks. The tagging operation may intercept or monitor file system interaction to classify storage blocks as operating system, application, and data files, as well as other classifications. Some embodiments may include file types, restrictions for physical location, access frequency, block size, and other metadata. The tags may be appended to storage blocks, stored in a separate database, or otherwise associated with the storage blocks. A storage management system may manage storage over many computing devices by handling the storage blocks according to the metadata tags.

### BACKGROUND

Storage systems are used to store data and various executable code for computer systems. In a typical storage system, blocks of storage are assigned by a file system, which may present files to an operating system or application. The file system may determine which blocks of data are assigned to which file. In many cases, an operating system or application may treat a file as a contiguous mass of storage, when in fact the file may be stored in many separate blocks or groups of blocks.

An operating system or application may treat various files differently. For example, some files may be accessed by one type of user, while other files may not. Some files may have read/write access, while other files may have read-only access.

In many cases, a file system may be a component in an operating system. Such designs may have a file system that may be shared by all applications as well as the operating system.

### SUMMARY

A storage management system may monitor file activity from a file system and tag storage blocks with metadata. The metadata may be used by the storage management system to apply various policies to the blocks. The tagging operation may intercept or monitor file system interaction to classify storage blocks as operating system, application, and data files, as well as other classifications. Some embodiments may include file types, restrictions for physical location, access frequency, block size, and other metadata. The tags may be appended to storage blocks, stored in a separate database, or otherwise associated with the storage blocks. A storage management system may manage storage over many computing devices by handling the storage blocks according to the metadata tags.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a computer system with a storage management system.

FIG. 2 is a diagram illustration of an embodiment showing a device with block level tagging and management.

FIG. 3 is a diagram illustration of an example embodiment showing a block tagging scheme.

FIG. 4 is a flowchart illustration of an embodiment showing a method for provisioning storage devices for a logical unit.

FIG. 5 is a flowchart illustration of an embodiment showing a method for configuring a logical unit for an image.

FIG. 6 is a flowchart illustration of an embodiment showing a method for processing a read request.

### DETAILED DESCRIPTION

A storage management system may tag blocks of storage while monitoring interaction with a file system. The tagged storage blocks may be used by a storage management system to apply different policies or service level agreements to blocks with various tags. The tagging system may permit the storage management system to configure logical units that may meet a service level agreement.

The tagging system may identify the general file classification, such as operating system executable, application executable, or data. From this type of classification, a storage manager may expect that operating system executable files to be accessed infrequently, application executable files to be accessed frequently, and data files to be access very frequently. In many embodiments, different policies may be applied to different classes of files. Since operating system executables may be accessed infrequently and may be duplicated on other devices within a datacenter, operating system files may be stored on low cost and less reliable storage.

In another example, data files that are frequently access may affect the overall performance of a system when those blocks are stored on poor performance storage. In such a case, data files may be placed on very high performance storage devices.

The contents of a data file may also be tagged. Some data, such as video files or audio files, may have the characteristic of being accessed in a sequential manner. Thus, video or audio files may be stored in such a manner to optimize read operations by placing blocks of data in a sequential layout on a hard disk or other rotating media. Other data files that are randomly accessed may be stored on other media that may have less latency when accessing a random block, such as various random access solid state storage media.

Many other examples of tagging parameters will be discussed later in this specification.

Once the blocks of data are tagged, a storage management system may place the blocks of data to comply with a service level agreement. In some cases, the tags may be embedded in each block, while in other cases the tags may be stored in a database. In either manner, the storage management system may place the blocks of data on an appropriate storage medium and move the blocks of data to other storage media when the service level agreement may not be met.

A storage management system may present a single logical unit while providing the logical unit on a plurality of devices. The storage management system may maintain a service level agreement by configuring the devices in different manners and placing blocks of data on different devices.

The storage management system may manage storage devices that may include direct attached storage devices, such as hard disk drives connected through various interfaces, solid state disk drives, volatile memory storage, and other media including optical storage and other magnetic storage media. The storage devices may also include storage available over a network, including network attached storage, storage area networks, and other storage devices accessed over a network.

Each storage device may be characterized using parameters similar to or derivable from a service level agreement. The device characterizations may be used to select and deploy devices to create logical units, as well as to modify the devices supporting an existing logical unit after deployment.

The service level agreement may define certain parameters that may be applied to storage blocks having the same characteristics. Such a system may allow certain types of blocks to have different service level parameters than other blocks.

The service level agreement may identify minimum performance characteristics or other parameters that may be used to configure and manage a logical unit. The service level agreement may include performance metrics, such as number of input/output operations per unit time, latency of operations, bandwidth or throughput of operations, and other performance metrics. In some cases, a service level agreement may include optimizing parameters, such as preferring devices having lower cost or lower power consumption than other devices.

The service level agreement may include replication criteria, which may define a minimum number of different devices to store a given block. The replication criteria may identify certain types of storage devices to include or exclude.

The storage management system may receive a desired size of a logical unit along with a desired service level agreement. The storage management system may identify a group of available devices that may meet the service level agreement and provision the logical unit using the available devices.

During operation of the logical unit, the storage management system may identify when the service level agreement may be exceeded. The storage management system may reconfigure the provisioned devices in many different manners, for example by converting from synchronous to asynchronous write operations or striping read operations. In some cases, the storage management system may add or remove devices from supporting the logical unit, as well as moving blocks from one device to another to increase performance or otherwise meet the storage level agreement.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

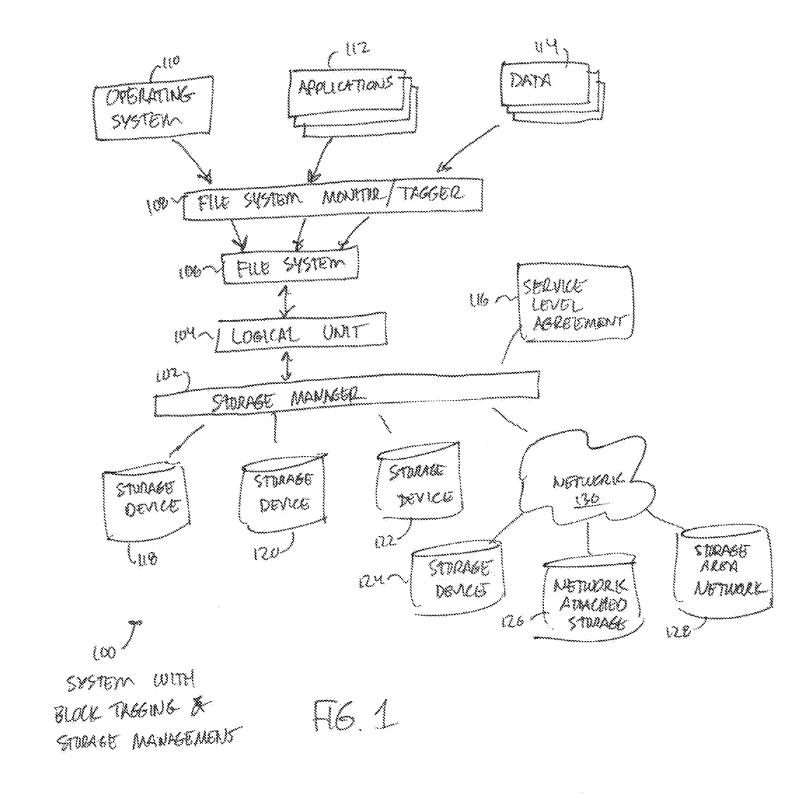

FIG. 1 is a diagram of an embodiment 100 showing a computer system with a storage management system. Embodiment 100 illustrates a storage management system 102 that creates a logical unit 104 that a file system 106 may use to store and retrieve data.

A file system monitor and tagger 108 may intercept or monitor communications from an operating system 110, various applications 112, and data files 114 to the file system 106. The file system monitor and tagger 108 may attempt to classify the files and tag the blocks associated with the file. The storage manager 102 may apply a service level agreement 116 to the tagged blocks that may define how to manage tagged blocks with certain characteristics.

The storage manager 102 may apply different policies to different categories or classes of blocks, as defined in the service level agreement 116. Because the blocks are tagged, the storage manager 102 may be able to manage individual storage blocks with an appropriate set of policies, where the policies may be applied on a file-by-file basis.

The storage manager 102 may place the blocks of data on various storage devices, such as locally connected storage devices 118, 120, and 122. In some embodiments, the storage manager 102 may be capable of storing blocks of data on various devices attached to a network 130, such as a generic storage device 124, a network attached storage device 126, and a storage area network 128.

In many cases, a service level agreement 116 may indicate that blocks with certain tagged properties may have one or more copies of the block stored on a remote device. Such service level agreements may provide redundancy in case that the local storage device may lose power or otherwise fail.

Embodiment 100 illustrates a mechanism by which policies may be applied to storage blocks by the file system monitor/tagger 108 yet the blocks may be managed individually. The file system monitor/tagger 108 may monitor interactions with the file system 106 to identify characteristics of a file, then tag the file so that a service level agreement tailored to the type of file may be implemented. The storage manager 102 may implement the service level agreement 116.

The storage management system 102 may use multiple storage devices to create and manage the logical unit 104. The logical unit 104 may operate as a single storage device to the file system 106, and the file system 106 may interact with the logical unit 104 as if the logical unit 104 was a single disk drive or other storage mechanism.

The storage management system 102 may provide more capabilities than a single storage device. For example, the storage management system 102 may store each block of data on multiple storage devices. By storing each block of data on multiple devices, a failure of one of the storage devices may not compromise data integrity, since each block of data may have at least one backup copy on another device. Further, an error or fault on one device may be arbitrated or resolved by comparing the data from one or more other devices.

Striped read access may be possible when each block of data may be stored on multiple devices. Striped read access may allow multiple devices to read a different block simultaneously, allowing the logical unit to respond to read requests of multiple blocks with a throughput that may be higher than any single device. In such a configuration, the performance of a logical unit may be greater than a single storage device. In some embodiments, striped write access may be implemented.

Write operations may be configured to be symmetric or asymmetric. Symmetric write operations may simultaneously write to two or more devices, and may not complete until the last of the devices has successfully completed the write operation. Asymmetric write operations may complete a write request to a single device, then may later propagate the data change to another device. Symmetric write operations may ensure data integrity and have higher fault tolerance because multiple devices have a complete, up to data version of the data prior to finishing the write request. In contrast, asymmetric write operations may be higher speed, as the write operations may be completed when the fastest device has successfully completed the operation.

In some embodiments, write operations may be performed in a symmetric manner as a default. However, a service level agreement may permit changing to asymmetric write operations during periods of high write demands.

The storage management system 102 may manage the logical unit 104 by placing blocks of data on various storage devices. The blocks of data may be presented to the file system 106 as a single storage device. In many embodiments, the file system 106 may not be aware that the logical unit 104 may not be composed of multiple storage devices.

The file system 106 may manage files of data which may be accessed by an operating system 110 and various applications 112. The file system 108 may also store data 114 that may be accessed by the operating system 110 and applications 112.

A service level agreement 116 may define the performance metrics and other characteristics of the logical unit 104. The storage management system 102 may create the logical unit 104 according to the service level agreement 116, and then manage the logical unit 106 to meet the service level agreement 116 during operation.

Prior to creating the logical unit 104, the storage management system 102 may take an inventory of available storage devices and store descriptors of the storage devices in a device database. The inventory may include static descriptors of the various devices, including network address, physical location, available storage capacity, model number, interface type, and other descriptors.

The inventory may also include dynamic descriptors that define maximum and measured performance. The storage management system 102 may perform tests against a storage device to measure read and write performance, which may include latency, burst and saturated throughput, and other metrics. In some embodiments, the storage management system 102 may measure dynamic descriptors over time to determine when a service level agreement may not be met or to identify a change in a network or device configuration.

The storage management system 102 may manage many different types of devices to create and manage the logical unit 106. The devices may include SAS disk drives, PCI flash memory, SATA disk drives, USB connected storage. Such devices may represent typical storage devices that may be available on a conventional server or desktop computer.

Some embodiments may manage storage available over a network 130. In such embodiments, other storage devices attached to other server or desktop computers may be used, as well as iSCSI storage, storage area networks, network attached storage, and various forms of cloud storage.

Each of the various types of devices may have different performance or other characteristics. For example, locally attached devices may have faster response times than network attached devices. Some devices may have a higher capital cost or a higher operating cost. In many cases, higher performance devices may come with an increased capital cost or energy consumption.

Some devices may different reliability characteristics. Spinning media, notably hard disk drives, may fail in a catastrophic fashion, while solid state storage media may tend to fail gradually.

In each case, the storage devices may store various blocks of data, as opposed to storing individual files. In some instances, a single file may have part of the file stored in a first group of blocks on a first device, while another part of the file may be stored in a second group of blocks on a second device.

The block level management of a logical unit may enable the storage management system 102 to treat each block of data separately. For example, some blocks of a logical unit 104 may be accessed frequently while other blocks may not. The frequently accessed blocks may be placed on a storage device that offers increased performance, such as a local flash memory device, while other blocks may be placed on a device that offers poorer performance but may be operated at a lower cost.

The storage management system 102 may create and manage a logical unit 104 to meet criteria defined in a service level agreement 116. The service level agreement 116 may define a size for the logical unit 104, number of replications of blocks of data, and various performance characteristics of the logical unit 104.

The size of a logical unit 104 may be defined using thin or thick provisioning. In a thick provisioned logical unit, all of the storage requested for the logical unit may be provisioned and assigned to the logical unit. In a thin provisioned logical unit, the maximum size of the logical unit may be defined, but the physical storage may not be assigned to the logical unit until requested.

In a thin provisioned logical unit, the storage management system 102 may assign additional blocks of storage to the logical unit 104 over time. When the amount of storage actually being used grows to be close to the physical storage assigned, the storage management system 102 may identify additional storage for the logical unit. The additional storage may be selected to comply with the storage level agreement 116.

The number of replications of blocks of data may define how many different devices may store each block, as well as what type of devices. The replications may be used for fault tolerance as well as for performance characteristics.

Replications may be defined for fault tolerance by selecting a number of devices that store a block so that if one of the devices were to fail, the block may be retrieved from one of the remaining devices. In some embodiments, a replication policy may define that a local copy and a remote copy may be kept for each block. Such a policy may ensure that if the local device were compromised or failed, that the data may be recreated from the remote storage devices. In some policies, such remote devices may be defined to be another device within the same or different rack in a datacenter, for example. In some cases, a replication policy may define that an off premises storage device be included in the replication.

The replications may define whether a write operation may be performed in a synchronous or asynchronous manner. In an asynchronous write operation, the write operation may complete on one device, then the storage management system 104 may propagate the write operations to another device. When an off premises or other remote storage is used, some replication policies may permit the remote storage to be updated asynchronously, while writing synchronously to multiple local devices.

Replications may be defined for performance by selecting multiple devices that may support striping. Striping read operations may involve reading from multiple devices simultaneously, where each read operation may read a different block or different areas of a single block. As all of the data are read, the various portions of data may be concatenated and transmitted to the file system 106. Striping may increase read performance by a factor of the number of devices allocated to the striping operation.

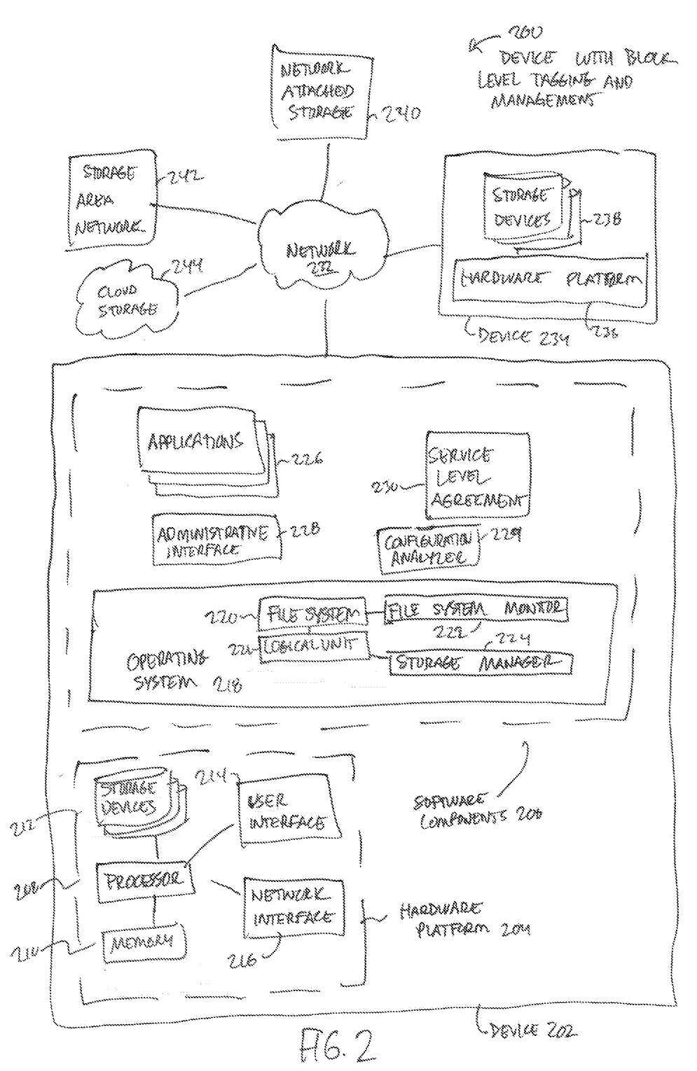

FIG. 2 is a diagram of an embodiment 200 showing a computer system with a storage management system that uses block level tagging. The storage management system may create and manage a logical unit for storage accessible by an operating system and applications, where the storage blocks may be tagged and managed independently of files or other storage constructs. Because the tagging may occur with knowledge of the files to which storage blocks occur, policies may be implemented on a file system level but the management of storage media may occur at a block level.

The diagram of FIG. 2 illustrates functional components of a system. In some cases, the component may be a hardware component, a software component, or a combination of hardware and software. Some of the components may be application level software, while other components may be execution environment level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 200 may illustrate an example of a device that may have a managed logical unit that may operate with tagged storage blocks. An operating system's file system may recognize the logical unit as a storage unit in the same way as a conventional disk drive may be treated as a storage unit. A storage management system may manage the logical unit by placing blocks of storage on multiple storage devices, which may provide a high degree of redundancy, fault tolerance, and increased performance over having the blocks of data stored on a single storage device.

A file system monitor may identify and tag storage blocks with characteristics of the files to which the blocks belong. Once the blocks are tagged, the storage system may apply different policies defined in a service level agreement to those blocks.

The storage management system may use a service level agreement to define how each storage block may be managed. The service level agreement may define various redundancy criteria, performance metrics, or other parameters for the logical unit. The storage management system may attempt to meet the service level agreement in the initial configuration of a logical unit, as well as make changes to the storage system to meet the service level agreement during operations.

Embodiment 200 illustrates a device 202 that may have a hardware platform 204 and various software components 206. The device 202 as illustrated represents a conventional computing device, although other embodiments may have different configurations, architectures, or components.

In many embodiments, the device 202 may be a server computer. In some embodiments, the device 202 may still also be a desktop computer, laptop computer, netbook computer, tablet or slate computer, wireless handset, cellular telephone, game console or any other type of computing device.

The hardware platform 204 may include a processor 208, random access memory 210, and nonvolatile storage 212. The hardware platform 204 may also include a user interface 214 and network interface 216.

The random access memory 210 may be storage that contains data objects and executable code that can be quickly accessed by the processors 208. In many embodiments, the random access memory 210 may have a high-speed bus connecting the memory 210 to the processors 208.

The nonvolatile storage 212 may be storage that persists after the device 202 is shut down. The nonvolatile storage 212 may be any type of storage device, including hard disk, solid state memory devices, magnetic tape, optical storage, or other type of storage. The nonvolatile storage 212 may be read only or read/write capable.

The user interface 214 may be any type of hardware capable of displaying output and receiving input from a user. In many cases, the output display may be a graphical display monitor, although output devices may include lights and other visual output, audio output, kinetic actuator output, as well as other output devices. Conventional input devices may include keyboards and pointing devices such as a mouse, stylus, trackball, or other pointing device. Other input devices may include various sensors, including biometric input devices, audio and video input devices, and other sensors.

The network interface 216 may be any type of connection to another computer. In many embodiments, the network interface 216 may be a wired Ethernet connection. Other embodiments may include wired or wireless connections over various communication protocols.

The software components 206 may include an operating system 218 that may have a file system 220 that interacts with a logical unit 221 provided by a storage management system 224. A file system monitor 222 may detect, classify, and tag each storage block managed by the storage manager 224. The operating system 218 may provide an abstraction layer between the hardware platform 204 and various software components, which may include applications, services, and various kernel and user level software components.

The file system 220 may create and manage files that may be accessed by the operating system 218 as well as various applications 226. The file system 220 may create files, apply permissions and various access controls to the files, and manage the files as distinct groups of storage.

The logical unit 221 may store the files in blocks of storage that may be allocated to the files. As files grow, additional blocks within the logical unit 221 may be assigned to the files.

The storage management system 222 may create and manage the storage according to a service level agreement 230.

A file system monitor 222 may detect all file system changes and may tag each block of data that may be created or changed with information that may enable the storage manager 224 to apply the service level agreement 230.

An administrative user interface 228 may have a user interface through which a system administrator may configure and manage the storage management system. The user interface may allow the administrator to define a logical unit 221 and set the parameters by which the logical unit 221 may be operated, which may include defining and editing a service level agreement 230. In some cases, the user interface may also allow the user to view the current and historical performance of the logical unit 221.

A configuration analyzer 229 may populate and update a database of available storage devices. The configuration analyzer 229 may discover all available storage devices and determine static and dynamic capacities of those devices. A static capacity may include currently available storage, physical location, network or local address, device type, and other parameters. Dynamic capacities may include various performance metrics that may be tested, measured, and monitored during operation. Such metrics may be burst and sustained bandwidth, latency, and other parameters.

The configuration analyzer 229 may monitor the storage devices over time. In some cases, the performance, capacity, or other parameters may change, which may trigger the storage management system 224 to make changes to the logical unit 221 in order to meet the service level agreement 230.

In some embodiments, the various storage management system components may communicate over a network 232 to access and manage various remote storage systems. A remote storage system may be a device 234 that has a hardware platform 236 on which various storage devices 238 may be made available. In some cases, the storage devices 238 may be iSCSI or other devices that may be accessed over a network 232. The remote storage systems may include network attached storage 240, storage area networks 242, cloud storage 244, and other storage devices that may be accessed over the network 232. In some cases, a service level agreement 230 may define that some or all of the blocks of data in the logical unit be stored on remote storage devices.

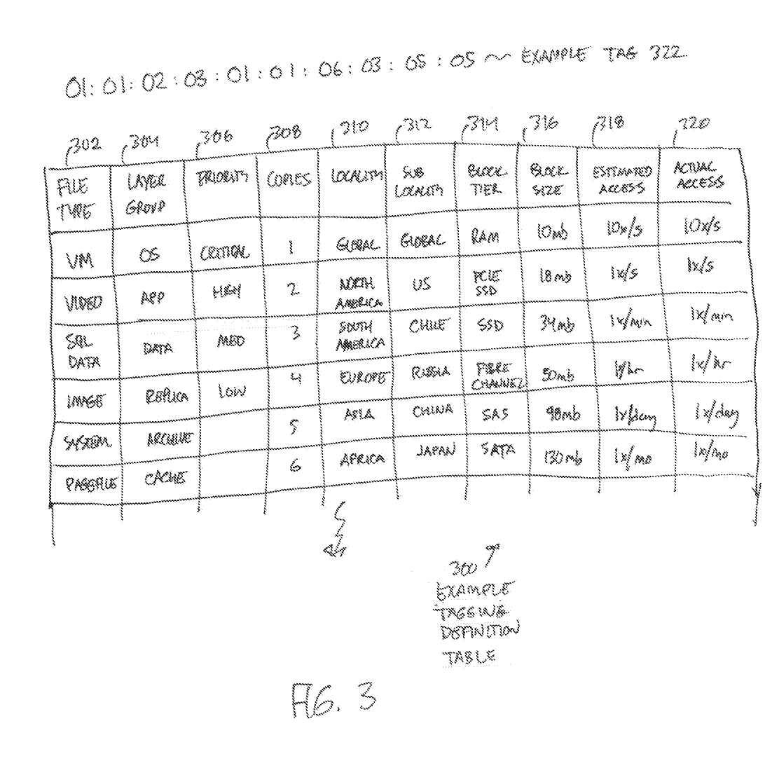

FIG. 3 is a diagram illustration of an example embodiment 300 showing a tagging definition table. An example tag 322 illustrates how one block of data may be tagged, and the table may illustrate how the example tag may be illustrated.

The example of embodiment 300 illustrates merely on example of the various parameters with which a block may be tagged. Other embodiments may have more or fewer parameters, different definitions for the various parameters, different sequences of parameter values, or other differences. The example of embodiment 300 is merely one form of a tagging system.

The example tag 322 may illustrate a tag that may contain values for each of a series of parameters. The tag 322 may be interpreted by examining the table, where each value in the series of values in the tag 322 represent the corresponding column in the table. The value within each element of the tab 322 may refer to the corresponding column of the tagging definition table.

The example of embodiment 300 is merely one mechanism to implement a tagging scheme. Other mechanisms may use different tag definitions, different meanings for the tag elements, different styles of representing a tag, and other different features.

The tag 322 may be associated with each storage block that makes up a logical unit. In some embodiments, a tag may be incorporated into each storage block, either by attaching the tag as a header or otherwise embedding the tag into the storage block. In some embodiments, a database may be used to store the tag and associate the tag with the specific block.

In the example of embodiment 300, the first column may be file type 302. The file type may be, for example, a virtual machine, video file, SQL data, image file, system file, pagefile, or some other type of file. The file type may be used by a storage manager to place blocks of data. Many different attributes of the file type may be used in placing the files on media.

For example, files associated with a virtual machine may be accessed randomly, as opposed to a video file which may be accessed sequentially. Sequentially read files may be optimized by being placed in sequence on spinning media. Video and image files are often read but not written. As such, such files may be placed on storage devices that have poor write performance but good read performance. SQL data, in contrast, may have read and write operations performed very frequently and thus may be appropriate for devices that support fast read and write operations.

In another example, Image files may be very infrequently read and even less frequently written. As such, image files may be appropriate for storage devices that are relatively slow.

A layer group 304 tag element may help the storage manager further determine how to handle the storage block. The layer may define whether the storage block may be associated with the operating system, application, data, replica, archive, or cache. Blocks that represent cached data may be transient as well as may be duplicated elsewhere, thus cached blocks may be placed in random access memory or other location that may not persist when power may be cycled. Archived or replica data may be longer term storage that may be accessed infrequently and thus may be placed on longer term storage. Data blocks may be accessed frequently and randomly, while application and operating system blocks may be accessed infrequently. Access to data blocks may have a large impact in the performance of a system and thus may be placed on very high performance devices.

A priority 306 tag element may define a level of importance of the block from a business or performance standpoint. Lower priority blocks may be placed on lower reliability devices, while higher priority blocks may be placed on higher reliability devices.

A copy 308 tag element may define the number of copies for the block. Some blocks may have only one copy stored on various devices, while other blocks may have multiple copies. Multiple copies may be useful to protect against one or more failures of storage devices.

A locality 310 tag and sublocality tag 312 may be used when certain data may be subject to various jurisdictional or export controls. For example, information that contains medical records, personally identifiable information, or other sensitive information may be regulated by law or contract to remain within a specific jurisdiction. In another example, some data may apply to one business market but not another. As such, information may be stored in a datacenter or other location that may be close to the intended users. The locality 310 tag and sublocality tag 312 may define geographic areas where a block may be permitted to reside.

A block tier 314 tag may define a storage tier on which a block of data may reside. The tier may be random access memory, solid state storage connected by PCID, conventional solid state storage, Fibre Channel connected storage, SAS devices, and SATA devices. The block tier 314 tag may be set by a storage manager to indicate where the block may be stored after analyzing the accesses of the block and determining the best location in order to meet a service level agreement.

A block size 316 tag may identify the block size. In some embodiments, each file may be stored using different block sizes. Some files, such as video and image files, may benefit from improved performance as large block sizes, while other files that may be smaller in size or are frequently written may benefit from smaller block sizes.

An estimated access frequency 318 and measured access frequency 320 tags may estimate and track, respectively, the number of accesses performed on a specific block. When a block may be allocated and information stored in the block, the system may determine an estimated access frequency 318. The estimated access frequency 318 may be used to configure a logical unit or to place the block in an appropriate storage device. As the block may be accessed, a storage manager may track the access frequency and update the access frequency as the measured access frequency 320.

In some cases, the storage manager may move a block to a different storage device when the actual or measured access frequency is much different from the estimated access frequency. For example, a block that may be accessed much more frequently than originally estimated may be moved to a higher performance storage device. Similarly, a block that may be accessed much less frequently may be moved to a lower performance storage device.

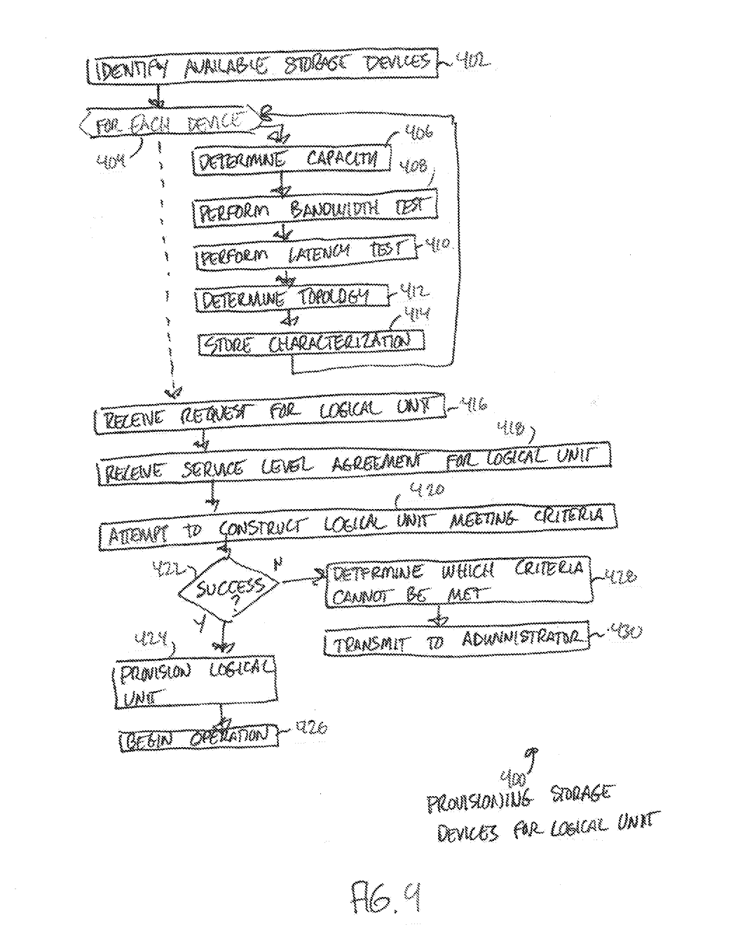

FIG. 4 is a flowchart illustration of an embodiment 400 showing a method for provisioning storage devices for a logical unit. Embodiment 400 illustrates one method by which a service level agreement may be used to configure and deploy a logical unit after gathering metadata about the available storage devices.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

In block 402, all of the available storage devices may be identified. In some embodiments, a crawler or other automated component may detect and identify local and remotely attached storage devices. In some embodiments, a user may identify various storage devices to the system. Such embodiments may be useful when remotely available storage devices may not be readily accessible or identifiable to a crawler mechanism.

For each device in block 404, the capacity may be determined in block 406. The capacity may include the amount of raw storage that may be available on the device.

A bandwidth test may be performed in block 408 to determine the burst and sustained rate of data transfer to and from the device. Similarly, a latency test may be performed in block 410 to determine any initial or sustained latency in communication with the storage device. In some embodiments, the bandwidth and latency tests may be a dynamic performance test, where the communication to the device may be exercised. In some embodiments, the bandwidth and latency may be determined by determining the type of interface to the device and deriving expected performance parameters.

A dynamic performance test may be useful when a storage device may be accessed through a network or other connection. In such cases, the network connections may add performance barriers that may not be determinable through a static analysis of the connections.

The topology of the device may be determined in block 412. The topology may define the connections from a logic unit to the storage device. The topology may include whether or not the device may be local to the intended computing device. For remotely located devices, the topology may include whether the device is in the same or different rack, the same or different local area network, the same or different datacenter or other geographic location.

In many embodiments, a service level agreement may enforce a duplication parameter where duplicates of each block may be stored in various remote locations. For example, a service level agreement may define that a copy of all blocks be stored in a datacenter within a specific country but remote from the device accessing the logical unit.

After determining the topology and other metadata about the storage devices, the characterization of the storage devices may be stored in block 414.

A request for a logical unit may be received in block 416. The service level agreement may be received in block 418 for the logical unit.

In block 420, an attempt to construct a logical unit may be made according to the service level agreement. The logical unit may be constructed by first identifying storage devices that may meet the performance metrics defined in a service level agreement. In some cases, the performance metrics may be met by combining two or more storage devices together, such as striping devices to increase read performance.

Once the performance metrics may be met, the storage capacity of a logical unit may be attempted to be met by provisioning the storage devices. In some cases, the provisioning may be thin provisioning, where the full physical storage capacity may not be assigned or provisioned, and where the full physical storage capacity may or may not be available at the time the storage is provisioned.

If the storage management system has determined that a logical unit may be provisioned with success in block 422, the logical unit may be provisioned in block 424 and may begin operation in block 426.

If the storage management system determines that the service level agreement may not be met in block 422 to result in a successful provisioning, the criteria that may not be met may be determined in block 428. These criteria may be presented to an administrator in block 430, and the administrator may elect to change the criteria or make other changes to the system to meet the criteria. In some cases, the administrator may add more storage devices to the available storage devices to meet the deficiencies identified in block 428.

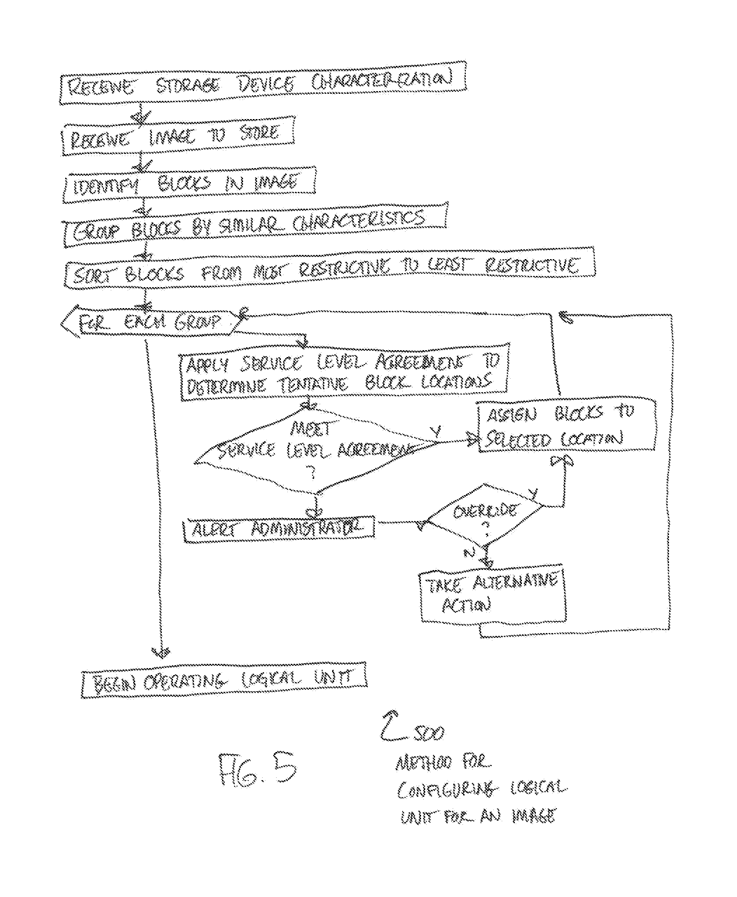

FIG. 5 is a flowchart illustration of an embodiment 500 showing a method for configuring a logical unit for a given image. Embodiment 500 illustrates one method by which blocks in an image may be examined and placed on a set of available storage devices to best meet a service level agreement.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

The characterizations of available storage devices may be received in block 502. The characterizations may define the capabilities, performance, and other parameters about the available storage devices.

An image may be received in block 504. An image may include all of the blocks for a logical unit, which may be identified in block 506. The image may contain blocks with different tags that define how the block may be classified and used.

The blocks may be grouped in block 508 by similar characteristics, and sorted in block 510 from the most restrictive to the least restrictive. Each group of blocks may be processed in block 512.

For each group of blocks in block 512, a service level agreement may be applied to identify tentative locations for the block. The service level agreement may define the desired performance, number of copies of blocks, and other parameters. In many cases, the service level agreement may define one set of parameters for one type of block and another set of parameters for another type of block. As such, each group of blocks may be treated differently by the service level agreement.

If the tentative placement of the blocks meets the service level agreement in block 516, the blocks may be assigned to the selected location in block 518. If the service level agreement is not met in block 516, an administrator may be alerted in block 520. The administrator may elect to override the service level agreement in block 522, in which case the blocks may be placed according to the selected location in block 518. Otherwise, the administrator may take alternative action in block 524, which may be to add more storage devices, change the placement of the logical unit, or other action.

Once each group is placed on the storage devices, the logical unit may begin operation in block 526.

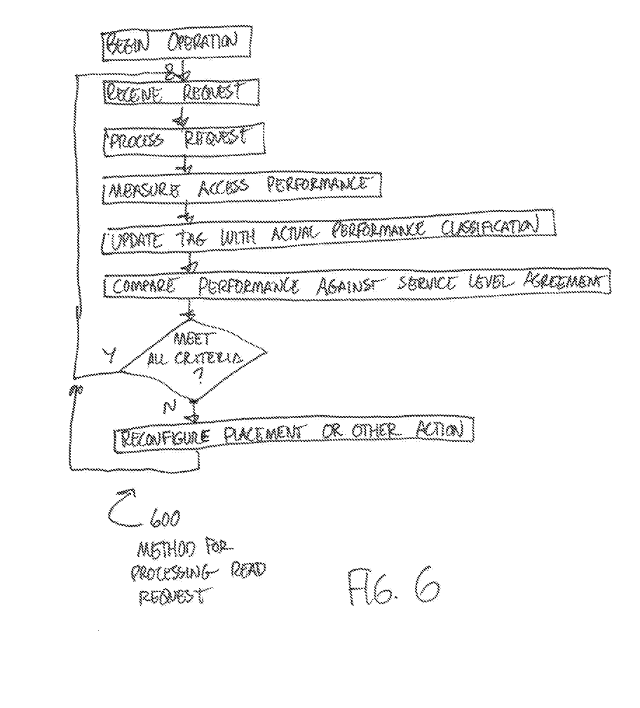

FIG. 6 is a flowchart illustration of an embodiment 600 showing a method for operating a logical unit and specifically processing a read request. Embodiment 600 illustrates how the service level agreement may be used to identify storage blocks that may be reconfigured to meet a service level agreement.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

A logical unit may begin operation in block 602. As part of normal operation, the logical unit may receive a request, which may be a read request, in block 604. The request may be processed in block 606.

During the operation, a storage manager may measure access performance of the system in block 608. The tags for any blocks processed by the system may be updated in block 610 with an actual or measured performance classification.

In the example of embodiment 300, a measured performance classification may be the access frequency of the block. In other embodiments, other or additional performance classifications may be used.

The actual or measured performance may be compared against the service level agreement in block 612. If the service level agreement is met in block 614, the process may return to block 604 to process additional requests. If the service level agreement is not met in block 614, the blocks may be reconfigured in block 616 or other action may be taken.

The reconfiguration in block 616 may move blocks from one storage device to another device that may have increased or decreased performance. For example, a block that may be accessed infrequently may be moved to a slower performing storage device, while a block that may be accessed very frequently may be moved to a higher performing storage device.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method performed on a computer processor, said method comprising:
receiving a file system request, said request identifying a first file;
determining a requestor for said file system request, said requestor being an executing process on said computer processor;
classifying said requestor as an owner type;
determining a set of blocks assigned to store said first file; and
tagging said set of blocks with said owner type.

2. The method of claim 1 further comprising:
determining an expected access frequency for said first file; and
tagging said set of blocks with said expected access frequency.

3. The method of claim 2 further comprising:
monitoring access to said first file to determine actual access frequency for said first file; and
tagging at least one of said set of blocks with said actual access frequency.

4. The method of claim 3 further comprising:
determining an actual access frequency for each of said set of blocks; and
tagging a first block in said set of blocks with a first actual access frequency and a second block in said set of blocks with a second actual access frequency.

5. The method of claim 2, said expected access frequency being defined by said executing process.

6. The method of claim 2, said expected access frequency being defined by a policy applied to said executing process.

7. The method of claim 6 further comprising:
determining a process classification for said executing process;
evaluating said policy with said process classification to determine said expected access frequency.

8. The method of claim 1 further comprising:
determining a dissemination restriction for said first file; and
tagging said set of blocks with said dissemination restriction.

9. The method of claim 8 further comprising:
monitoring a physical location for said set of blocks; and
restricting movement of said set of blocks to comply with said dissemination restriction.

10. The method of claim 1 further comprising:
determining an expected access frequency for said first file;
tagging said set of blocks with said expected access frequency;
determining a dissemination restriction for said first file;
tagging said set of blocks with said dissemination restriction;
determining a block size for said first file;
tagging said set of blocks with said block size;
determining a block tier for said first file; and
tagging said set of blocks with said block tier.

11. A system comprising:
a processor;
an operating system executing on said processor;
a file system that processes file commands;
a file system monitor that:
detects a file system request, said request identifying a first file;
determines a requestor for said file system request, said requestor being an executing process on said computer processor;
classifies said requestor as an owner type;
determines a set of blocks assigned to store said first file; and
tags said set of blocks with said owner type in a tag.

12. The system of claim 11, said tags being defined for each of said blocks in said set of blocks.

13. The system of claim 11, said file system monitor that further:
determines an expected access frequency for said first file;
tags said set of blocks with said expected access frequency;
determines a dissemination restriction for said first file;
tags said set of blocks with said dissemination restriction;
determines a block size for said first file;
tags said set of blocks with said block size;
determines a block tier for said first file; and
tags said set of blocks with said block tier.

14. The system of claim 11 further comprising:
a storage manager that:
identifies a plurality of storage devices, at least two of said storage devices having different performance characteristics;
determines an initial placement for said set of blocks amongst said plurality of storage devices that complies with said tag.

15. The system of claim 14, said storage manager that further:
receives a service level agreement for said first file; and
determines said initial placement to meet said service level agreement.

16. The system of claim 15, said storage manager that further:
monitors access to each of said blocks in said set of blocks;
determines that a first block is being accessed in a manner such that said service level agreement is not being met; and
moves said first block from a first storage device to a second storage device.

17. The system of claim 16, said second storage device having a different set of performance characteristics than said first storage device.

18. A system comprising:
a processor;
an operating system operating on said processor;
a file system operating as part of said operating system;
a file monitor that:
detects a file request;
determines that said file request relates to a first file;
determines that said first file is stored in a set of storage blocks;
tags said set of storage blocks with:
a classification for a process calling said file request;
a file type; and
a set of storage parameters for said file, said storage parameters comprising a minimum number of redundant copies and physical location restrictions;
a storage manager that:
receives a service level agreement;
creates a logical unit comprising storage from a plurality of storage devices, said logical unit storing said first file;
selects a subset of said plurality storage devices to store said first file, said subset being selected to comply with said tags; and
detects when access to said first file violates said service level agreement.

19. The system of claim 18, said tag being stored within said set of storage blocks.

20. The system of claim 18, said tab being stored in a tag database separate from said storage blocks.
